(19) United States
(12) Patent Application Publication
(10) Pub. No.: US 2018/0286169 A1
(43) Pub. Date: Oct. 4, 2018

(54) ROULETTE BASED GAME

(71) Applicant: Ghazwan BRIKHO, West Bloomfield, MI (US)

(72) Inventor: Ghazwan BRIKHO, West Bloomfield, MI (US)

(21) Appl. No.: 15/778,488

(22) PCT Filed: Nov. 16, 2016
(86) PCT No.: PCT/US2016/062325

§ 371 Date: May 23, 2018

Related U.S. Application Data
(60) Provisional application No. 62/258,771, filed on Nov. 23, 2015.

(51) Int. Cl. G07F 17/32; A63F 5/00

(52) U.S. Cl. CPC G07F 17/322; A63F 5/007; A63F 5/0094; A63F 5/0088

(57) ABSTRACT

An enhanced roulette game is provided with more exciting game play with differing odds as compared to traditional roulette. The roulette game has a two-track roulette wheel for the simultaneous use of two separate balls during game play, with an increased number of betting numbers of 63 (1-60, 0, 00, and 000) or 75 (0, 00, 000, 1-72) around a single course of pockets or cassettes. One of the two roulette balls may be a “gold” ball that represents a bonus payout or bonus for hitting both numbers for one or more players. A set of playing chips have radio frequency identification (RFID), or other locating devices that interact with the grid to determine chip placement on the betting layout to automatically calculate a bet payoff.

### FIELD OF THE INVENTION

The present invention generally relates to gaming, and more specifically to systems and methods for modified and enhanced roulette.

### BACKGROUND

Roulette is a game of chance named after the French word meaning little wheel. In a game of roulette, players may choose to place bets on either a single number or a range of numbers, the colors red or black, or whether the number is odd or even. A winning roulette number and color is determined when a croupier spins a wheel in one direction, then spins a ball in the opposite direction around a circular track running around the circumference of the wheel. The ball eventually loses momentum and falls onto the wheel and into one of 37 (in French/European roulette) or 38 (in American roulette) colored and numbered pockets or cassettes on the wheel.

FIG. 1 illustrates a typical prior art roulette table 10. The roulette wheel 12 has a series of pockets 14 that are numbered from 1 to 36. In number ranges from 1 to 10 and 19 to 28, odd numbers are red and even are black. In ranges from 11 to 18 and 29 to 36, odd numbers are black and even are red. There is a green pocket numbered 0 (zero). In American roulette, there is a second green pocket marked 00. Pocket number order on the roulette wheel adheres to the following clockwise sequence in most casinos:

### Single-Zero Wheel

0-32-15-19-4-21-2-25-17-34-6-27-13-36-11-30-8-23-10-5-24-16-33-1-20-14-31-9-22-18-29-7-28-12-35-3-26

### Double-Zero Wheel

0-28-9-26-30-11-7-20-32-17-5-22-34-15-3-24-36-13-1-00-27-10-25-29-12-8-19-31-18-6-21-33-16-4-23-35-14-2
   The cloth covered betting area 16 on a roulette table 10 is known as the layout.

The advent of new gambling venues and games of chance has led to a decrease in the popularity of roulette. Thus, there is a need for an enhanced system and method to increase the game playing appeal of roulette.

### SUMMARY OF THE INVENTION

A roulette based game system includes a roulette wheel with an upper track and a lower track around a circumferential edge of the roulette wheel with a series of numbered and color coded pockets arranged in a circle concentric with the roulette wheel. A first roulette ball and a second roulette ball for simultaneous play use the upper track and the lower track of the roulette wheel, respectively. A table surface holds the roulette wheel and a betting layout in a grid corresponding to the number of pockets in the roulette wheel for placing bets on the outcome of a roll of the roulette wheel. A set of playing chips that have radio frequency identification (RFID), or other locating devices interact with the grid to determine chip placement on the betting layout to automatically calculate a bet payoff.

A method for playing roulette includes placing bets on the outcome of a roulette wheel roll by placing chips on the betting layout. The roulette wheel is spun and a first and second ball are launched in an upper and lower track of the roulette wheel, respectively. The numbered and color coded pockets receive the first and second ball as their momentum decays to determine winning numbers and winning bets are paid.

### BRIEF DESCRIPTION OF THE DRAWINGS

The present invention is further detailed with respect to the following drawings. These figures are not intended to limit the scope of the present invention but rather illustrate certain attributes thereof wherein:

FIG. 1 depicts a prior art roulette table;

FIGS. 2A and 2B illustrate perspective views of an inventive roulette table in accordance with embodiments of the invention;

FIG. 3 illustrates a cross-sectional view of the inventive roulette wheel of FIG. 2A with two separate ball tracks in accordance with embodiments of the invention;

FIG. 4 depicts an inventive betting layout with 63 numbers (0, 00, 000, 1-63) in accordance with embodiments of the invention;

FIG. 5 depicts an inventive betting layout with 75 numbers (0, 00, 000, 1-72) in accordance with embodiments of the invention;

FIG. 6 depicts an inventive betting layout with 50 numbers (0, 00, 000, 1-47) in accordance with embodiments of the invention; and

FIG. 7 depicts an inventive roulette wheel with 75 numbers (0, 00, 000, 1-72) in accordance with embodiments of the invention.

### DETAILED DESCRIPTION OF THE INVENTION

The present invention has utility as a system and method for an enhanced roulette game. Embodiments of the inventive roulette game provide for more exciting game play with differing odds as compared to traditional roulette. Embodiments of the inventive roulette game have a two-track roulette wheel for the simultaneous use of two separate balls during game play, with an increased number of betting numbers of 50 (0, 00, 000, 1-47), 63 (0, 00, 000, 1-60), or 75 (0, 00, 000, 1-72) around a single course of pockets or cassettes. In a specific embodiment one of the two roulette balls may be a “gold” ball that represents a bonus payout or bonus for hitting both numbers for one or more players.

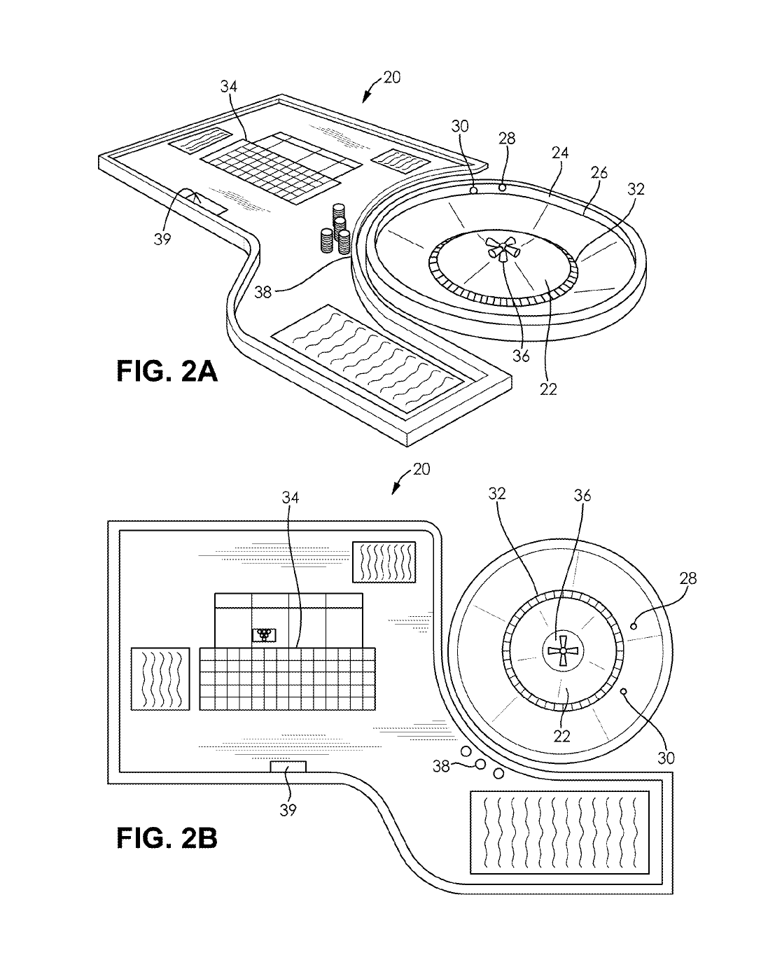

Referring now to the figures, FIGS. 2A and 2B are perspective views of the inventive roulette gamming table 20. The roulette wheel 22 has an upper track 24 and a lower track 26 for a first roulette ball 28 and a second roulette ball 30, respectively. A series of pockets 32 are arranged in a circle that correspond to the betting numbers shown in the betting layout 34. The betting layout shown in FIGS. 2A and 2B (shown in greater detail in FIG. 4) have 63 numbers (0, 00, 000, 1-60).

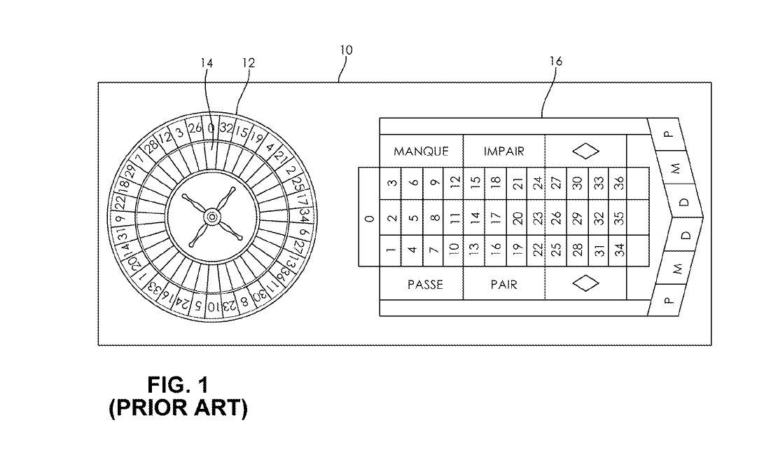

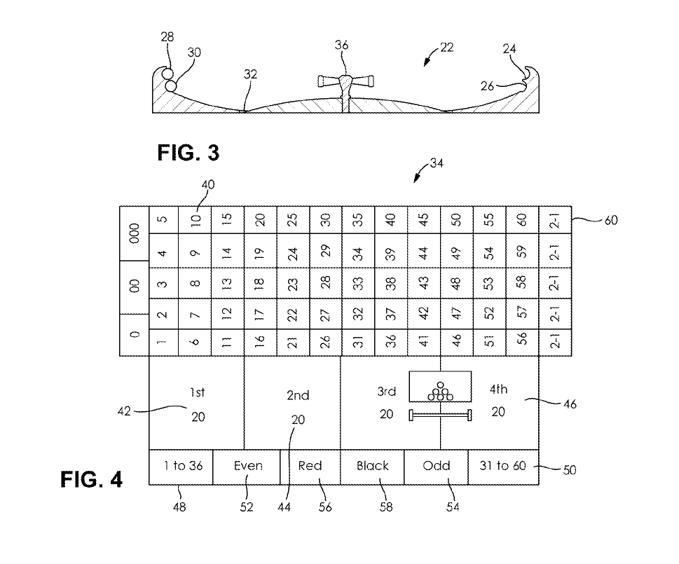

FIG. 3 illustrates a cross-sectional view of the inventive roulette wheel of FIG. 2A with two separate ball tracks, an upper track 24 and a lower track 26 for the first roulette ball 28 and the second roulette ball 30, respectively. As with traditional roulette wheels as described with respect to FIG. 1, as the first and second balls lose momentum the balls fall onto the wheel and into one of colored and numbered pockets or cassettes 32 on the wheel. The croupier (table operator) spins the wheel 22 using the handle 36.

FIG. 4 depicts an inventive betting layout 34 with 63 numbers (0, 00, 000, 1-60) shown as a grid 40 that corresponds to the roulette wheel of FIGS. 2A and 2B. As with traditional roulette the placement of chips 38 on the numbers, borders, corners, lines, or other areas of the layout 34 designate a players picks (and combinations thereof) for a roulette roll. Areas 42, 44, and 46 are representative for betting on the 1^{st} 20 numbers (1-20), 2^{nd} 20 numbers (21-40), and 3^{rd} 20 numbers (41-60), respectively. Bets on numbers 1-30 or 31-60 are placed via areas 48 and 50, respectively. Bets on an even or odd number are placed via areas 52 and 54, respectively. Bets on the color red or black that corresponds to the pocket the roulette balls fall into are chosen via placement of chips in areas 56 and 58, respectively. A 2 for 1 is chosen with chips placed in the areas 60 of the betting layout 34.

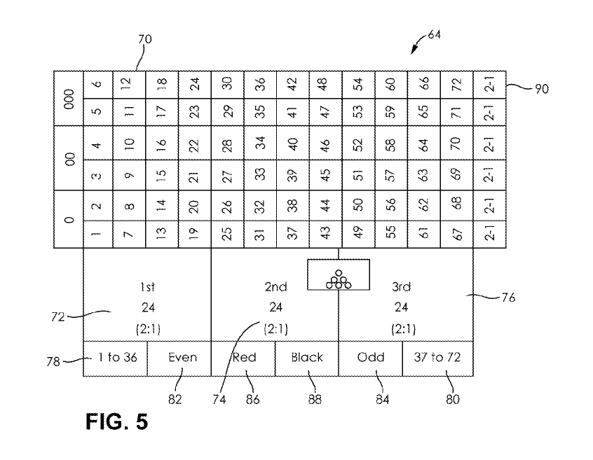

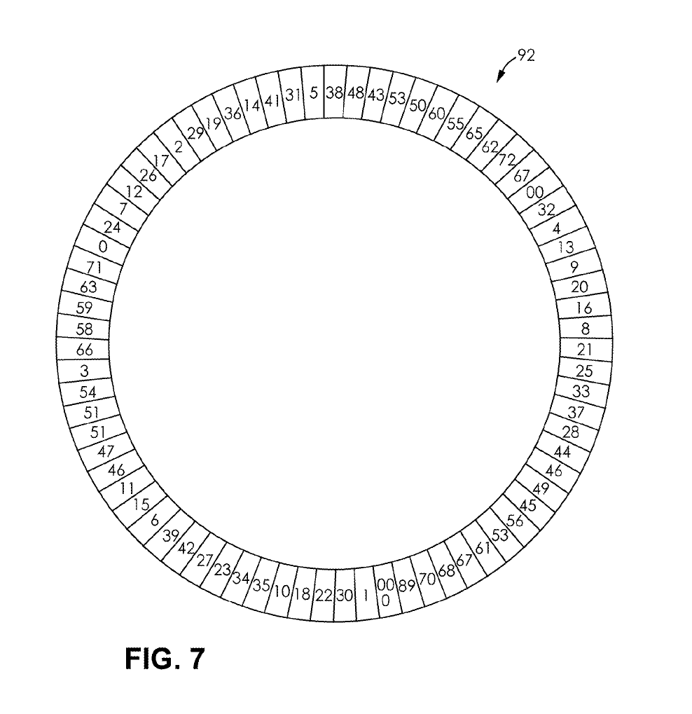

FIG. 5 depicts an inventive betting layout 64 with 75 numbers (0, 00, 000, 1-72) shown as a grid 70 that corresponds to the roulette wheel 92 of FIG. 7. As with traditional roulette the placement of chips 38 on the numbers, borders, corners, lines, or other areas of the layout 64 designate a players picks (and combinations thereof) for a roulette roll. Areas 72, 74, and 76 are representative for betting on the 1^{st} 24 numbers (1-24), 2^{nd} 24 numbers (25-48), and 3^{rd} 24 numbers (49-72), respectively. Bets on numbers 1-36 or 37-72 are placed via areas 78 and 80, respectively. Bets on an even or odd number are placed via areas 82 and 84, respectively. Bets on the color red or black that corresponds to the pocket the roulette balls fall into are chosen via placement of chips in areas 86 and 88, respectively. A 2 for 1 is chosen with chips placed in the areas 90 of the betting layout 64.

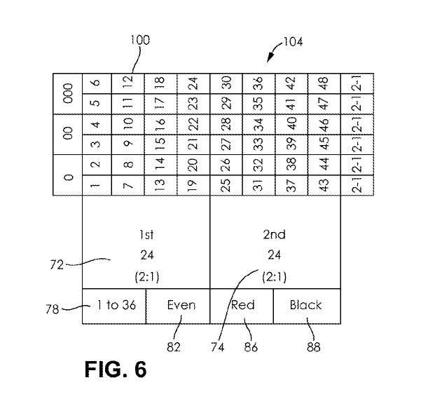

FIG. 6 depicts an inventive betting layout 104 with 50 numbers (0, 00, 000, 1-47) shown as a grid 100. As with traditional roulette the placement of chips 38 on the numbers, borders, corners, lines, or other areas of the layout 104 designate a players picks (and combinations thereof) for a roulette roll. Areas 102, 106, and 108 are representative for betting on the 1^{st} 24 numbers (1-24), 2^{nd} 24 numbers (25-48), and 3^{rd} 24 numbers (49-72), respectively. Bets on numbers 1-36 or 37-72 are placed via areas 78 and 80, respectively. Bets on an even or odd number are placed via areas 82 and 84, respectively. Bets on the color red or black that corresponds to the pocket the roulette balls fall into are chosen via placement of chips in areas 86 and 88, respectively. A 2 for 1 is chosen with chips placed in the areas 90 of the betting layout 64.

The player chips 38 may be equipped with radio frequency identification (RFID), or other locating devices that interact with the grid (40, 70, 100) to determine chip placement of a player to automatically calculate a bet payoff. The table holding the inventive roulette wheel may be equipped with a tower having a listing of numbers to indicate past numbers, with current numbers for a roll set as flashing. An electric eye may be used to sense winning numbers and post such information to a board for historical context viewing by players.

Table 1 and Table 2 provide a listing of the table odds and payoff for various roulette rolls.

TABLE 1
Table odds for 63 number roulette wheel.

| | Table odds |
|---|---|
| Single | 30-1 |
| 2 numbers | 15-1 |
| 3 numbers | 10-1 |
| 4 numbers | 8-1 |
| 5 numbers | 6-1 |
| 8 numbers | 4-1 |
| 10 numbers | 3-1 |
| 12 numbers | 2-1 |
| 20 numbers | 1-1 |
| Odd | 1-1 |
| Even | 1-1 |
| Red | 1-1 |
| Black | 1-1 |

TABLE 2
Table odds for 75 number roulette wheel.

| | Table odds |
|---|---|
| Single | 35-1 |
| 2 numbers | 17-1 |
| 3 numbers | 11-1 |
| 4 numbers | 8-1 |
| 6 numbers | 6-1 |
| 9 numbers | 4-1 |
| 12 numbers | 2-1 |
| 24 numbers | 1-1 |
| Odd | 1-1 |
| Even | 1-1 |
| Red | 1-1 |
| Black | 1-1 |

With reference to the roulette wheel 92 of FIG. 7, Double Win Roulette is a variation on standard Roulette. The Double Win Roulette wheel has seventy-five total slices; seventy-two slices numbered 1 through 72, one 0 slice, one 00 slice, and one 000 slice. Double Win Roulette also utilizes two independent balls per round, with one ball designated as the Golden Ball. The balls may land in separate wheel slices or the same wheel slice.

To begin gameplay, the player makes any combination of the wagers listed in Table 3 and Table 4. When wagering on the Single Number wager, the player is paid depending on how many balls land within the slice marked by the player's wager. All other wagers are paid based on the slice in which the Golden Ball lands only. The cost of a wager includes both balls.

TABLE 3
Double Win Roulette single number wager and pays

| Wager | One Ball | Two Balls |
|---|---|---|
| Single Number | 35 to 1 | 70 to 1 |

TABLE 4
Double Win Roulette other wagers and pays

| Wager | Golden Ball |
|---|---|
| 2 Numbers | 17 to 1 |
| 3 Numbers | 11 to 1 |
| 4 Numbers | 8 to 1 |
| 6 Numbers | 6 to 1 |
| 9 Numbers | 4 to 1 |
| 12 Numbers | 3 to 1 |
| 18 Numbers | 2 to 1 |
| Odd | 1 to 1 |
| Even | 1 to 1 |
| Red | 1 to 1 |
| Black | 1 to 1 |
| 1-36 | 1 to 1 |
| 37-72 | 1 to 1 |

A math analysis for Double Win Roulette was performed theoretically using probability theory. The probability of each event occurring was calculated, and those probabilities were used to determine the Return to Player (RTP) and House Edge (HE) for all wagers. These results are summarized in Table 5 and Table 6.

TABLE 5
Single number probabilities for RTP and HE

| Wager | Probability (1 ball) | Probability (2 Balls) | RTP | HE |
|---|---|---|---|---|
| Single | 0.0263 | 0.0002 | 95.911% | 4.02% |
| Number | | | | |

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes can be made in the function and arrangements of elements without departing from the scope as set forth in the appended claims and the legal equivalents thereof.

The foregoing description is illustrative of particular embodiments of the invention, but is not meant to be a limitation upon the practice thereof. The following claims, including all equivalents thereof, are intended to define the scope of the invention.

1. A roulette based game system, comprising:
a roulette wheel with an upper track and a lower track around a circumferential edge of the roulette wheel;
a series of numbered and color coded pockets arranged in a circle concentric with said roulette wheel:
a first roulette ball and a second roulette ball for simultaneous play using the upper track and the lower track of the roulette wheel; and
a table surface holding the roulette wheel and a betting layout in a grid corresponding to the number of pockets in the roulette wheel for placing bets on the outcome of a roll of the roulette wheel.

2. The system of claim 1 wherein said series of numbered and color coded pockets correspond to 63 numbers, the 63 numbers consisting of 0, 00, 000, and 1-60.

3. The system of claim 2 wherein said layout has a grid of 63 numbers (0, 00, 000, 1-60), and areas for placing bets on one or more of the following: 1^{st} 20 numbers (1-20), 2^{nd} 20 numbers (21-40), and 3^{rd} 20 numbers (41-60); numbers 1-30, numbers 31-60; even or odd, red or black; and 2 for 1.

4. The system of claim 1 wherein said series of numbered and color coded pockets correspond to 75 numbers, the 75 numbers consisting of 0, 00, 000, and 1-72.

5. The system of claim 4 wherein said layout has a grid of 75 numbers (0, 00, 000, 1-72), and areas for placing bets on one or more of the following: 1^{st} 24 numbers (1-²⁴), 2^{nd} 24 numbers (25-48), and 3^{rd} 24 numbers (49-72); numbers 1-36, numbers 37-72; even or odd, red or black; and 2 for 1.

6. The system of claim 1 wherein a set of playing chips have radio frequency identification (RFID), or other locating devices that interact with the grid to determine chip placement on the betting layout to automatically calculate a bet payoff.

7. The system of claim 1 further comprising a tower having a listing of numbers to indicate past numbers, with current numbers for a roll set as flashing.

8. The system of claim 1 further comprising an electric eye.

9. A method for using the system of claim 1 comprising:
placing bets on the outcome of a roulette wheel roll by placing chips on the betting layout;
spinning the roulette wheel;
launching the first and second balls in the upper and lower tracks, respectively;
determining which numbered and color coded pockets the first and second ball land in when the roulette wheel stops spinning;
determining which bets paid off; and
rewarding the winning bets.

10. The method of claim 9 wherein the first and second ball land in separate pockets or land in the same pocket.
